(19) United States
(12) Patent Application Publication
(10) Pub. No.: US 2007/0271222 A1
(43) Pub. Date: Nov. 22, 2007

(54) Methods for Scheduling Automatic Download of Data From Internet to a Portable Device

(75) Inventor: Yong Fu, San Ramon, CA (US)

Correspondence Address: EMIL CHANG;LAW OFFICES OF EMIL CHANG, 874 JASMINE DRIVE, SUNNYDALE, CA, 94086, US

(73) Assignee: CASGLE, LLC, San Ramon, CA (US)

(21) Appl. No.: 11/750,653

(22) Filed: May 18, 2007

Related U.S. Application Data
(60) Provisional application No. 60/802,014, filed on May 18, 2006.

(51) Int. Cl. G06F 17/30; G06F 15/16

(52) U.S. Cl. 707/2; 707/1; 709/217

(57) ABSTRACT

A method for downloading episodes from the internet to a portable media playback device that allows users freely define the daily playtime, the storage capacity to use, and then select and schedule episodes to be downloaded as a function of the available storage capacity and playtime. The method further defines a graphical user interface that displays the scheduling and related information of the episodes.

### CROSS REFERENCE

This application claims priority from a United States provisional patent application entitled “Method for Scheduling Automatic Download From Internet to a Portable Device” filed on May 18, 2006 having an application No. 60/802,014. This application is incorporated herein by reference.

### FIELD OF INVENTION

This invention relates generally to the field of internet services and more particularly to methods and apparatuses for scheduling automatic download of data from internet to portable devices.

### BACKGROUND

With the popularity of the portable media devices and the enrichment of the media content on the internet, podcast has been developed to simplify the management of online media content. Unlike songs, online media program are updating sporadically with new episodes at scheduled intervals such that the propagation of online media program are more like the broadcasting of radio programs and TV shows. In one aspect, podcasting is a method of automatically distributing content programs (audio, video, document, etc) over the internet for playback on portable devices and personal computers. This automatic method works well with frequently updated podcast programs, greatly reduces the burden of manual searching and synchronizing for new episodes on a daily basis. The downloaded content saved in PC can be further synchronized to portable media device. Users have the choice of whatever they want to listen or watch, and whenever and wherever they want to.

As of today, Apple, Yahoo, MSN all provide software programs running on personal computer with podcast function. Podcast program list is maintained so users can choose the programs they like. Users can also schedule the time new content is checked and how the new content is downloaded. To save on storage, user can also specified if all the downloaded episodes will be saved or only the latest one(s) will be saved into the portable media player.

The software provided from Apple, Yahoo, MSN is initially designed for music searching and download. Podcast programs are updated more frequently. To get the programs downloaded regularly or daily, users have to power on the computer. They have to plug in the MP3 players in order to synchronize the new content to portable player. This download approach, works OK with downloading music, since users will not download very often. But this approach is clearly a burden for the frequently updated online media content.

This application is related to Application Ser. No. 60/791,293, entitled “Apparatus and method for automatically downloading information through internet and providing the feedback to service provider”. In that application, an apparatus and method for automatically downloading information to the portable device is described. This application, further disclose a method to manage the download list, play list so users have the full control and easily create their fully personalized media station.

### SUMMARY OF THE INVENTION

An object of the invention is to provide an easy and straight forward method for scheduling the content download that is especially useful for portable media devices which have limited storage capacity for content.

Another object of the invention is to manage the download schedule based on both the capacity of storage and the user's time that can spend on listening/watching the downloaded content.

Another object of the invention is to interface with the users so that the user can fully customize their own media download and play list on regular daily bases.

Other objects and advantages of the present invention will become apparent from the following descriptions, taken in connection with the accompanying drawings, wherein, by way of illustration and example, an embodiment of the present invention is disclosed.

Briefly, in a presently preferred method for downloading episodes from the internet to a portable media playback device, wherein the episodes are updated from time to time, comprising the steps of: determining the update schedule for available episodes; presenting the schedule to a user; determining the available amount of daily playtime for each day of interest; determining the available amount of storage space for the portable media playback device; selecting by the user the download schedule for certain ones of the available episodes as a function of the available amount of daily playtime for each day of interest and the available amount of storage space; and downloading the selected episodes to the portable media playback device according to the download schedule.

An advantage of the invention is that it provides an easy and straight forward method for scheduling the content download that is especially useful for portable media devices which have limited storage capacity for content.

Another advantage of the invention is that it manages the download schedule based on both the capacity of storage and the user's time that can spend on listening/watching the downloaded content.

Another advantage of the invention is that it interfaces with the users so that the user can fully customize their own media download and play list on regular daily bases.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the embodiments of the invention.

FIG. 1 illustrates a system architecture;

FIG. 2 depicts a format for a user interface of an embodiment of the present invention;

FIG. 3 is a definition of certain attributes of a content program;

FIG. 4 is a format of a definition of a publish schedule; and

FIG. 5 is a flow chart of the steps that comprise a method of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In the presently preferred embodiment, users are able to manage content program or episodes in a more organized way. As will be described in more details below, the management method will take care of the storage limitation of the portable device and the user's daily time that can spend on the downloaded content. The method have a graphic user interface so users can easily move a program content download time from one day to another, and change the order of the program so that play sequence could be adjusted.

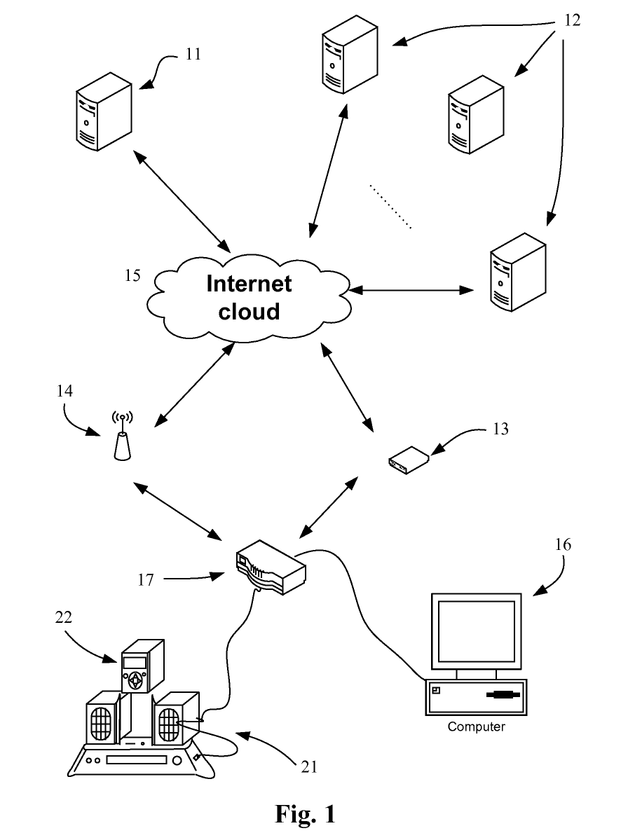

FIG. 1 illustrates an online system in accordance with an embodiment of the present invention. A management server 11 maintains a subscriber's information and maintains the content list. The content servers 12 can be maintained by content service providers. All the servers connect into the internet cloud 15. On the user's side, the apparatus 21 and user's PC 16 usually connect to a hub or router 17. The router (or hub) 17 further connects to internet 15 through either wireless method 14, such as 802.11x or wired method 13, such as ADSL, cable modem. Once the system is established, user can access the apparatus 21 through PC 16 for the initial setup and the content list management. The content list will be saved into the apparatus 21 so then the download can be done without the PC 16. Once the update checking time comes or the portable media device 22 is plugged in, the apparatus 21 will first check with the server 11 to get the latest information and find out which content needs to be updated. Then it will connect to the content server 12 to acquire the content and download directly into the portable media device 22.

While the user has registered and has the program list picked up, there will be several issues need to solve before downloading a program. First, the portable content player usually has limited storage capacity. Even the physical storage in the devices could be up to 20 GB, the space could be reserved for other usage such as saving the songs users buy from other channels, so it can not be given unlimited space for the automatically downloaded content. Second, as a media channel, user usually has limited time spending on it. For example, many people listen to audio program on the road. With the limited usage time, user may still download programs having program playtime longer than the users' available listening time—just in case they want to download more to have more choices, but it does not make sense to download programs a lot more than what they can listen or watch per day. The downloading or playlist management program as described in this patent helps to solve this issue.

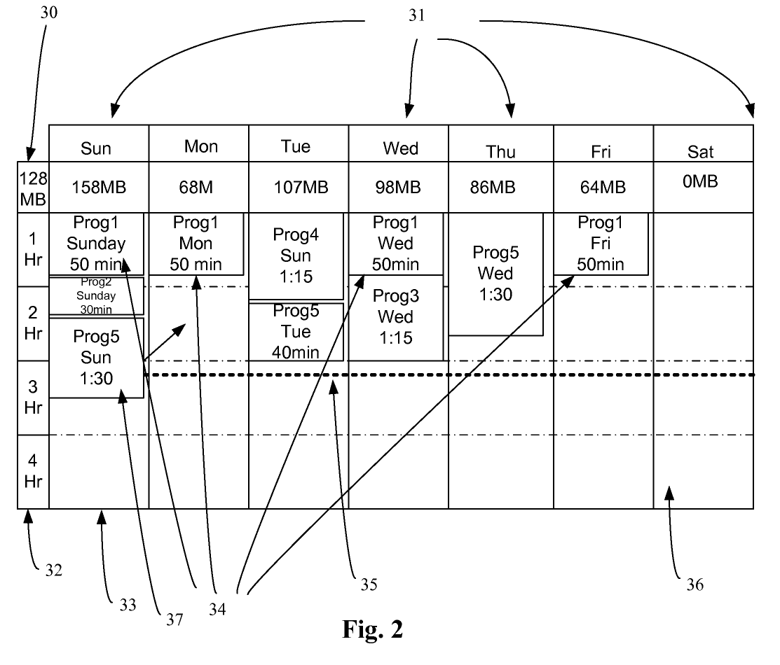

FIG. 2 depicts an embodiment of a user interface of a management program of the present invention. The program is running on a PC as either a standalone program or a web based program. The interface shows in a form of table with its columns 31 organized as week days or date of month. The first row displays the storage capacity usage. The maximum capacity, which is the cell in the first column, could be setup by users and usually it is not the same as the maximum capacity of the portable device physically has. Each cell in that row is the sum of the size of each episode in that day. For example, for Sunday as shown in the FIG. 2, the total maximum size of program 1, program 2 and program 5 is 158 MB, and for Saturday, since the user does not have time to listen or watch, there is no download needed so the download size is 0 MB.

Under the storage column 30 is the program list row. On the side is the label of hour 32. Users can setup the time that they have each day for listening/watching programs, and the setup can be displayed as a dash line 35, which may be adjustable for each day. In FIG. 2, as illustrated, users currently set the time for listen/watch is 3 hours and 15 minutes.

Each program can be shown as one or more blocks. For example, program 1 has 4 episodes published on Sunday, Monday, Wednesday and Friday, and it is shown that program 5 37 has only 1 block since the program is published once per week. Each block shows the program name, the date when that episode is published, and the length of the program. The length of each block represents the play time of the program. The organized sequence of the programs for a particular day can be the playlist for that day. As show in 33, each Sunday, the play sequence is 50 minutes of program 1, 30 minutes of program 2 and 1.5 hour of program 5.

Users can freely move each block up and down in each day so that the play list (sequence) can be changed, and can freely move each block to other dates other than its first available day. For example, the current setting means user will have 3.5 hours downloaded program which exceed the time user can deliver to listen/watch, users then can move program 5 of the Sunday release to Monday.

After user finish the setup, it can be saved. User will have the fully customized download schedule and the play list.

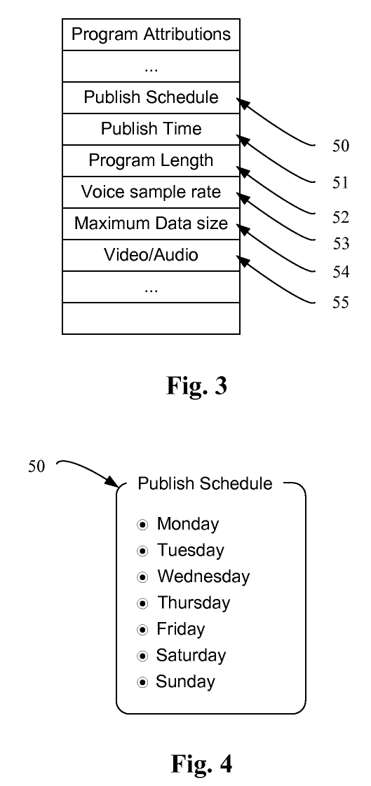

The program has some attributions that can tell the software that receives the program. Some of the attributions have been defined in the RSS/ATOM standard. RSS/ATOM is the technology behind the podcast. To support the function mentioned above, some new attributions are defined. FIG. 3 is a list of attributions of content program that are defined in this patent. Those attributions already defined in RSS/ATOM standards are not listed. Publish Schedule 50 is when the episodes of a program is published. Publish time 51 tell what time within a day that the program is published. Program length 52 is the number of minutes of each episode of a program. Voice sample rate 53 is a reference to tell how the audio program is encoded, such as 128 kbps, 64 kbps, 32 kbps, etc. Maximum Data size 54 is the maximum file size of one episode in a program. Video/Audio 55 indicate if the program is an audio or a video program.

FIG. 4 is a format for a definition of a publish schedule. The publish schedule can be set to be weekly based.

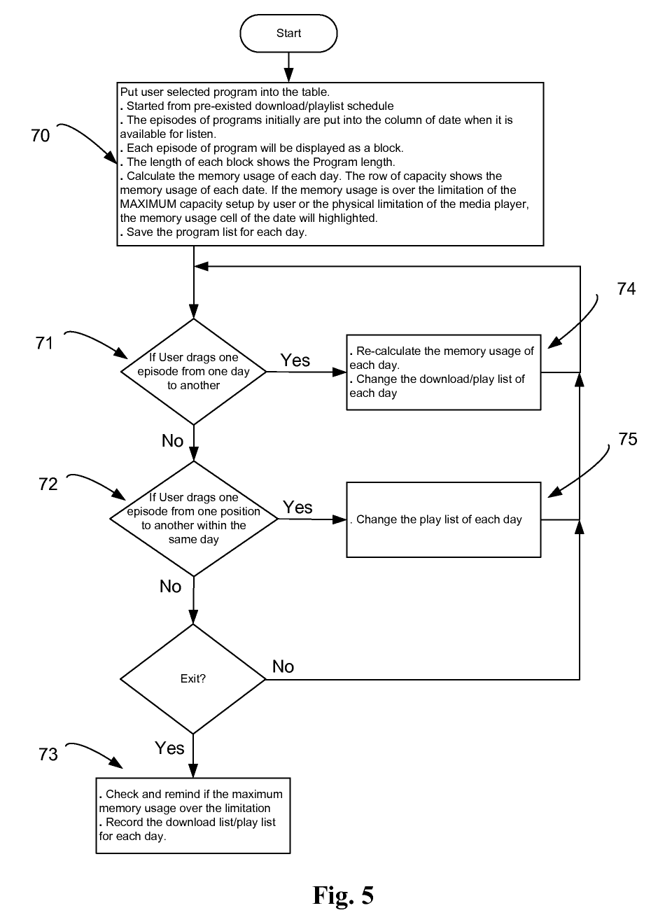

FIG. 5 is a flow chart of the operations that comprise the method. When the schedule manager start 70, the pre-existing downloads and playlist can be displayed. The blocks of episodes of newly added programs can be put initially at the day when it first available. For example, if a program is published on each Saturday, the block of that episode can be put in Saturday. From the graphic user interface, users can see the total download of each day, and the play list of each day.

If the user drags one episode from one day to another 71, the management software re-calculates the memory usage of the days, and records the change in the download/play list accordingly 74. If the user drags one episode up and down within a day 72, the software records the change in the play list 75.

After the setup is done, the final download/play list is recorded 73. The user does not need a computer 16 unless they want to change the lists again, for example, dropping programs they do not like any more, or adding new programs. What they can do everyday is simply plug the portable media device 22 into the adaptor station 21, a much simpler device described in the above referenced patent applications. Adaptor can communicate with a manage server 11, and the manager server 11 would know which program has new updates and would direct the adaptor station 21 to download the new episodes from the content servers 12.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for downloading episodes from the internet to a portable media playback device, wherein the episodes are updated from time to time, comprising the steps of:
determining the update schedule for available episodes;
presenting the schedule to a user;
determining the available amount of daily playtime for each day of interest;
determining the available amount of storage space for the portable media playback device;
selecting by the user the download schedule for certain ones of the available episodes as a function of the available amount of daily playtime for each day of interest and the available amount of storage space; and
downloading the selected episodes to the portable media playback device according to the download schedule.

2. The method of claim 1 wherein a graphical user interface is provided to the user in presenting the schedule to the user and wherein the graphical user interface displays the episodes in accordance to the respective playtime of the respective episodes.

3. The method of claim 1 wherein the graphical user interface displays publishing schedule, publishing time, episode length, and maximum data size.

4. A method for downloading episodes from the internet to a portable media playback device, wherein the episodes are updated from time to time, comprising the steps of:
determining the update schedule for available episodes;
presenting the schedule to a user using a graphical user interface displaying publishing schedule, publishing time, episode length, and maximum data size;
determining the available amount of daily playtime for each day of interest;
determining the available amount of storage space for the portable media playback device;
selecting by the user the download schedule for certain ones of the available episodes as a function of the available amount of daily playtime for each day of interest and the available amount of storage space; and
downloading the selected episodes to the portable media playback device according to the download schedule.

5. The method of claim 1 wherein a graphical user interface is provided to the user in presenting the schedule to the user and wherein the graphical user interface displays the episodes in accordance to the respective playtime of the respective episodes.

6. A method for downloading episodes from the internet to a portable media playback device, wherein the episodes are updated from time to time, comprising the steps of:
determining the update schedule for available episodes;
presenting the schedule to a user using a graphical user interface displaying publishing schedule, publishing time, episode length, and maximum data size, wherein the graphical user interface displays the episodes in accordance to the respective playtime of the respective episodes;
determining the available amount of daily playtime for each day of interest;
determining the available amount of storage space for the portable media playback device;
selecting by the user the download schedule for certain ones of the available episodes as a function of the available amount of daily playtime for each day of interest and the available amount of storage space; and
downloading the selected episodes to the portable media playback device according to the download schedule.
